(19) United States
(12) Patent Application Publication
(10) Pub. No.: US 2015/0154579 A1
(43) Pub. Date: Jun. 4, 2015

(54) Compact Payment Terminal

(71) Applicant: Mordechai Teicher, Hod Hasharon (IL)

(72) Inventor: Mordechai Teicher, Hod Hasharon (IL)

(21) Appl. No.: 14/611,412

(22) Filed: Feb. 2, 2015

Related U.S. Application Data
(63) Continuation of application No. 12/791,005, filed on Jun. 1, 2010.
(60) Provisional application No. 61/183,570, filed on Jun. 3, 2009.

(51) Int. Cl. G06Q 20/18; G06Q 20/32

(52) U.S. Cl. CPC G06Q 20/18; G06Q 20/322

(57) ABSTRACT

A compact payment terminal for operating upon a purchase made by a customer at a retail device is provided. The customer carries a mobile communication device that includes a payment module and a communication module. The compact payment terminal includes a first interface for interfacing with the retail device, a second interface for interfacing with the mobile communication device of the customer and a processing unit connected to the first and second interface. The compact payment terminal is configured to receive, via the first interface, a payment request from the retail device, cooperate, via the second interface, with the payment module of the mobile communication device for initiating a payment transaction respective to the payment request, and selectably conduct, via the second interface and the communication module of the mobile communication device, a communication session between the processing unit and at least one server.

### CROSS REFERENCE TO RELATED APPLICATIONS

This application is a continuation of patent application Ser. No. 12/791,005 filed on 1 Jun. 2010, which claims the benefit of U.S. provisional patent application No. 61/183,570 filed on 3 Jun. 2009, both applications incorporated by reference as if set forth herein.

### BACKGROUND OF THE INVENTION

1. Field of the Invention

The present invention relates to electronic payment systems, and in particular to merchant payment terminals for mobile payment.

2. Description of Related Art

Electronic payment is ubiquitous. Consumers present personal payment devices, such as credit cards, debit cards, stored-value cards, key fobs or mobile phones, for paying electronically for goods and services.

A typical electronic payment transaction starts when a customer presents a card or another personal payment device at a merchant payment terminal, and is ultimately completed when conventional money moves into the merchant's bank account. An enormous system—a payment system—of computers, communication networks, procedures and rules operates in the background to enable electronic payment and make it simple to use and sufficiently secure for all parties involved. The point-of-contact of the customer with a payment system is an issuer, whose main roles are to provide the payment card to the customer, and collect money from the customer for the value spent electronically. The point-of-contact of the merchant with a payment system is an acquirer, whose main roles are to provide the payment terminal to the merchant, and reimburse the merchant with money for the value received electronically. There are additional players, operating in the background to close the loop between issuers and acquirers and administer the rules and operations of payment systems, such as domestic clearinghouses, global payment organizations, transaction processors, and regulators.

Charge transactions are credit or debit transactions. In a charge transaction, the card (or another personal payment device) is associated with an account managed on a server of an issuer, under a credit or debit arrangement. When presenting the card at a merchant payment terminal, the customer may be requested for personal authentication, for example by entering a personal identification number (PIN) or presenting a biometric credential, such as a fingerprint. Then, in a typical charge transaction, the card details and the requested payment amount are sent by the payment terminal to the acquirer for online payment authorization. The acquirer, in turn, sends a similar query to the respective issuer, and upon the issuer verifying that the card is valid and sufficient funds are available, the issuer approves that transaction to the acquirer, which ends up with the acquirer authorizing the transaction to the payment terminal. The transaction is then completed at the payment terminal by being recorded in the payment terminal along with other payment transactions made within the same business cycle. At the end of the business cycle, for example every midnight, the records of all transactions accumulated within the business cycle are sent by the payment terminal to the acquirer for settlement. The acquirer reimburses the merchant's bank account for the total amount of all received payments, possibly with some service fees deducted. The acquirer then approaches the issuers of all cards presented within the business cycle with all merchants served by the acquirer, and collects the respective totals, possibly with some fees deducted, from each respective issuer. From the customer's and merchant's point of view, a payment session for a specific purchase is ultimately completed upon the paid amount being added to the merchant's bank account, while being deducted from the customer's bank account (for a debit card), or added to the customer's debt (for a credit card).

For larger merchant locations, such as in a supermarket with tens of cash registers, a plurality of payment terminals may handle card acceptance and customer authentication, while a payment hub, which is a server positioned within the store or remotely, communicates with the payment terminals and handles the communication with acquirers for authorization and settlement.

Stored-value payment is based on electronic representation of money stored on a card. The stored-value is centrally generated at a stored-value pool, and is loaded into a stored-value card (also dubbed “electronic purse”) against payment by cash or charge. Upon making a stored-value payment at a stored-value payment terminal, stored-value moves from the electronic purse to the stored-value payment terminal. At the end of the business cycle, for example at midnight, the payment terminal connects with a stored-value acquirer for exchanging the aggregated stored-value against real money, which is deposited, less applicable service fees, in the merchant's bank account. Stored-value payment does not require authorization and settlement of individual transactions, and is therefore faster, cheaper and less dependent on communication availability and reliability. On the other hand, it is considered less secure, and value stored in the card is often lost with a lost or stolen card. Accordingly, it is widely accepted that stored-value is optimal for small payments (micropayments) while charge payment is better suited for larger payments.

Charge & change payment relates to a payment system that makes use of synergistic cooperation between charge and stored-value functionalities implemented within a single card, as described in U.S. Pat. No. 5,744,787, entitled “System and method for retail”, and U.S. Pat. No. 6,076,075, entitled “Retail unit and a payment unit for serving a customer on a purchase and method for executing the same”, both of which are incorporated by reference as if set forth herein in their entirety. In that system, a card and a payment terminal include both charge and stored-value capabilities; larger payments are automatically referred to charge, while smaller payments are either paid by stored-value from the card's electronic purse (if the appropriate amount is available), or a minimum charge amount (for example, $25) is charged to the card, and the remainder ($25 less the purchase price) is returned by stored-value from the payment terminal to the card's electronic purse. U.S. Pat. Nos. 6,119,946 and 6,467,685, both entitled “Countable electronic monetary system and method” and incorporated by reference as if set forth herein in their entirety, add a functionality of cost-effective audit for stored-value, by using stored-value that is composed of serialized electronic coins of various denominations. U.S. Pat. No. 6,065,675, entitled “Processing system and method for a heterogeneous electronic cash environment”, also incorporated by reference as if set forth herein in its entirety, teaches the seamless integration of a stored value system into the operational modes and business models of existing credit and debit payment systems.

Smart cards use secure chips that are embedded within the cards for storing and exchanging sensitive data. The smart card technology uses the combination of cryptography and tamper-proof integrated circuits to make it impractical, or at least economically-unattractive, for unauthorized persons to read or modify data stored within the chip and representing personal credentials, access rights or stored-value. Smart cards are vastly used in mobile communication, satellite television, credit and debit cards, and stored-value cards.

Contactless smart cards allow chip-to-chip secure communication without applying conductive electrical contacts. At least one of the two communicating chips (the active chip) must be energized by being hardwired to an electrical power supply, while the other chip may often be energized from its active peer by electromagnetic induction. Near Field Communication (NFC) technology allows small, low cost active chips to be embedded even in small devices, and more and more mobile telephones are equipped with an embedded NFC chip for a variety of commercial applications.

Mobile payment is a family of emerging payment applications, attempting to leverage the ubiquity, communication, processing power and security of mobile telephones, as well as the customer base and billing arrangements of mobile operators. Lack of clear advantage to consumers and merchants, governance conflicts between mobile operators and the legacy charge payment systems, and the possibility of cannibalization of airtime sales by billing for other merchants' goods, make mobile payment lagging below expectations.

It will be appreciated that there is a large variety of payment systems, and the background review above is highly generalized and may be incomplete or inaccurate in certain specific cases.

Cash is still the king in many retail applications such as vending, parking, mass transit, fast food, newsstands, and kiosks, all of which are characterized by low-value payments that cannot justify the charge transaction cost, and/or by a low number of daily visits that cannot justify the cost of a conventional payment terminal. Cash has well-known drawbacks of security risks, collection costs, and unavailability in the proper form with many would-be customers. Accordingly, it could be advantageous to have a low-cost compact payment terminal that can be afforded in any retail situation. It could be further advantageous to have such a payment terminal with stored-value capability for affording low-value payment transactions.

### SUMMARY OF THE INVENTION

The present invention seeks to provide a low-cost compact payment terminal for receiving payments from mobile communication devices, such as mobile phones.

### DEFINITIONS

By “customer” or “user” is meant a person making a purchase and paying for it electronically. By “merchant” is meant a person or an institution selling goods or services and getting paid electronically.

By “electronic payment transaction”, also abbreviated “electronic payment” or “payment”, is meant any of: a charge transaction; a stored-value transaction; and a charge & change transaction. A “charge” transaction is an instruction to transfer funds from a payer account managed by a financial institution under a credit or debit arrangement. A “stored-value” transaction is the transfer of prepaid funds represented electronically and stored on a payment device, to a merchant payment terminal. A “charge & change transaction” is based on the cooperation between charge and stored-value functionalities of both a customer payment device and a merchant payment terminal, as taught by U.S. Pat. Nos. 5,744,787, 6,076,075, and optionally also by U.S. Pat. Nos. 6,119,946, 6,467,685, 6,065,675, all of which are incorporated by reference as if set forth herein in their entirety. It will be noted that the teachings of U.S. Pat. Nos. 6,119,946 and 6,467,685, as well as the teachings of U.S. Pat. No. 6,065,675, may be implemented also with stored-value transactions other than charge & change, for enhancing their auditing and settlement aspects, respectively.

By “personal payment device” is meant a personal device carried by a customer and presented for electronic payment. Examples for a personal payment device include a plastic card having a magnetic stripe, a plastic card having an embedded contact or contactless chip (a smart card), a key fob having a contactless payment chip, and mobile communication devices having a payment functionality installed or programmed therein. A personal payment device can be configured to carry one or more electronic payment forms, such as charge (credit/debit), stored-value, and charge & change.

By “settlement” is meant a transaction between a merchant and a financial institution (an “acquirer”) for transforming received electronic value into conventional monetary funds transferred to an account of the merchant. The received electronic value can be in the form of recorded charge transactions and/or stored-value.

By “online payment authorization”, also abbreviated “payment authorization” or “authorization”, is meant an online confirmation received by a merchant from its acquirer with respect to a specific payment transaction. Authorization is typically verified by the acquirer with the respective card issuer, prior to presenting the confirmation to the merchant.

By “retail device” is meant herein a device used upon purchase for determining the sold items and calculating the purchase price. Retail devices may be manual or automatic. An example for a manual retail device is a cash register. Examples for automatic retail devices are vending machines and parking meters.

By “payment terminal” is meant a device that receives a payment request, interfaces with a personal payment device, receives user credentials for user authentication, where applicable, and returns a signal of payment success or failure. Some payment terminals are standalone units that conduct complete payment, transaction recording, authorization and settlement sessions, while other payment terminals communicate with a “payment hub” that is a server, placed within a retail location or remotely, that handles centrally: optionally part of the payment transaction payment (including stored-value transfer, where applicable); authorization; transaction recording; and settlement; for a plurality of payment terminals.

By “mobile communication device” is meant a portable device carried by a person and capable of wireless communication trough communication networks. A cellular telephone, a two-way pager and a personal digital assistant (PDA) are representative examples of mobile communication devices.

By “acquirer server” is meant one or more computers communicated by the merchant payment terminal for settlement and, where appropriate, for payment authorization. In a compact case, the acquirer server is operated by a single institution for settling all payment forms accepted by the payment terminal such as credit, debit, stored-value, and charge & change. In another case, the acquirer server is implemented as a plurality of servers operated by several financial institutions, and the payment terminal communicates with the appropriate server according to the payment form and/or payment device brand.

### BRIEF SUMMARY

In its broadest sense, a compact payment terminal according to preferred embodiments of the present invention eliminates from its design one or more elements that are included in typical conventional payment terminal designs, such as: customer user interface, merchant user interface, power supply, and communication means for connecting with a payment hub or with an acquirer server for authorization and settlement. In a very compact implementation, a preferred embodiment of the present invention can be described as a “payment terminal on a chip” that temporarily borrows customer and merchant user interfaces, acquirer communication and possibly also electrical power, from mobile communication devices of visiting customers that are placed next to the compact payment terminal for making a payment. Internally, however, a standalone compact payment terminal preferably secures, stores, and communicates data according to standard payment, authorization, and settlement protocols, so that it can seamlessly integrate within standard payment systems and infrastructures that also serve standard payment terminals. In another preferred embodiment, a compact payment terminal uses the communication capability of a visiting mobile phone for communicating with a payment hub that handles authorization and settlement transactions on behalf of a plurality of compact payment terminals.

### DETAILED DESCRIPTION OF PREFERRED EMBODIMENTS OF THE INVENTION

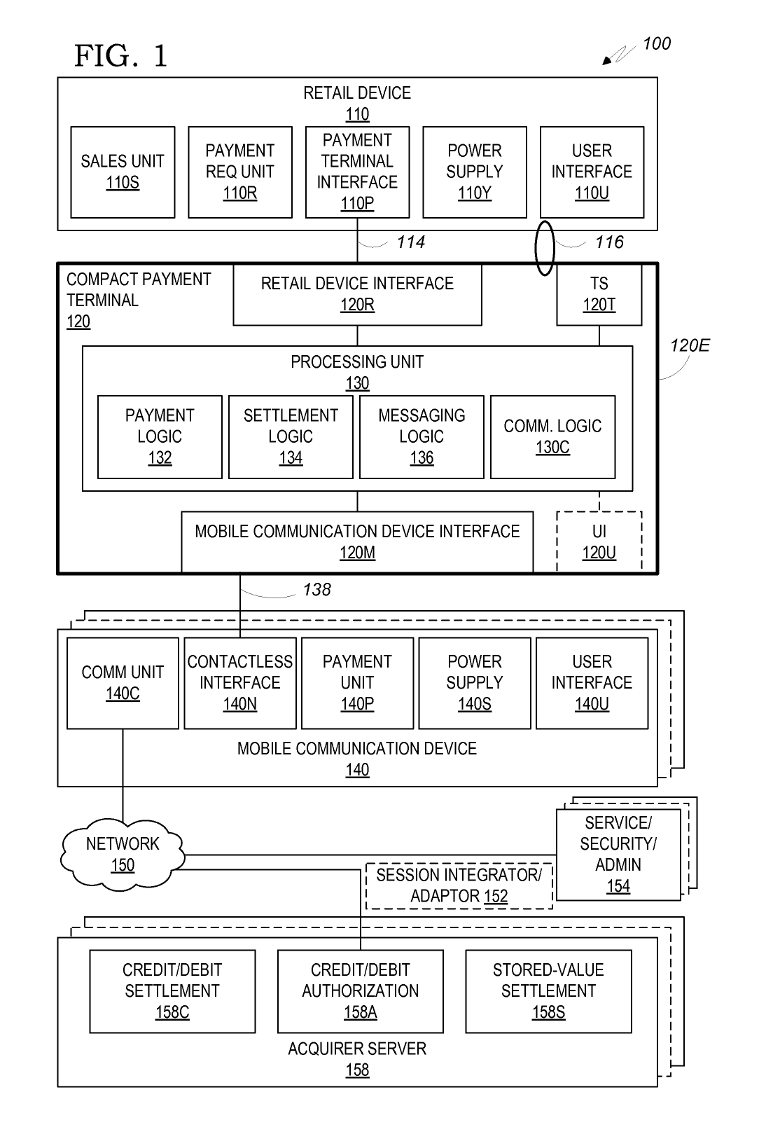

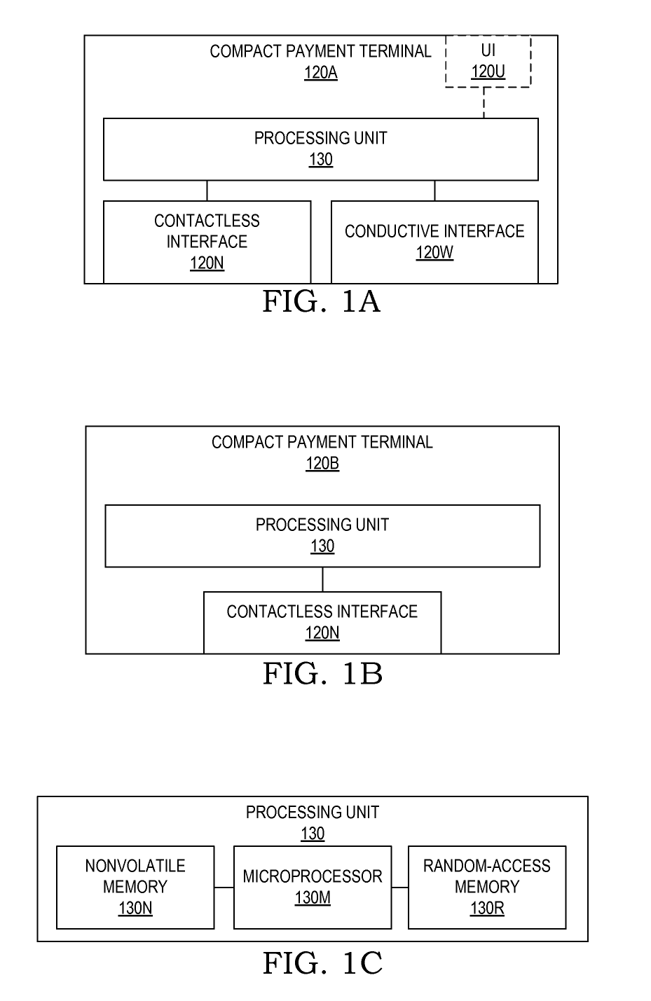

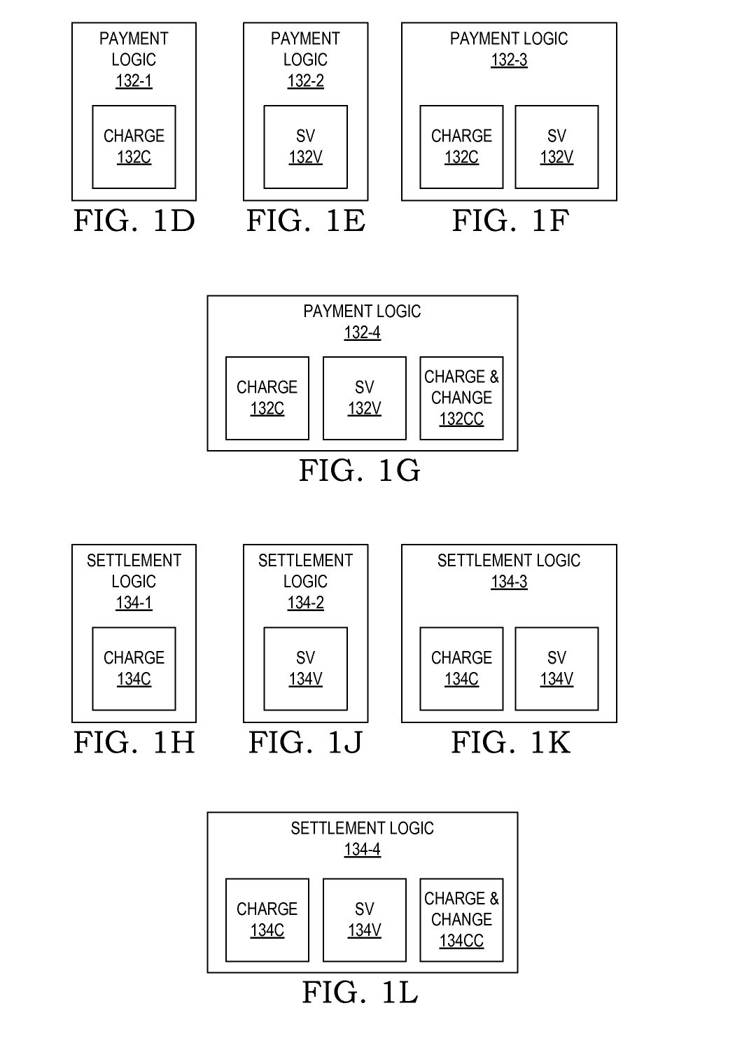

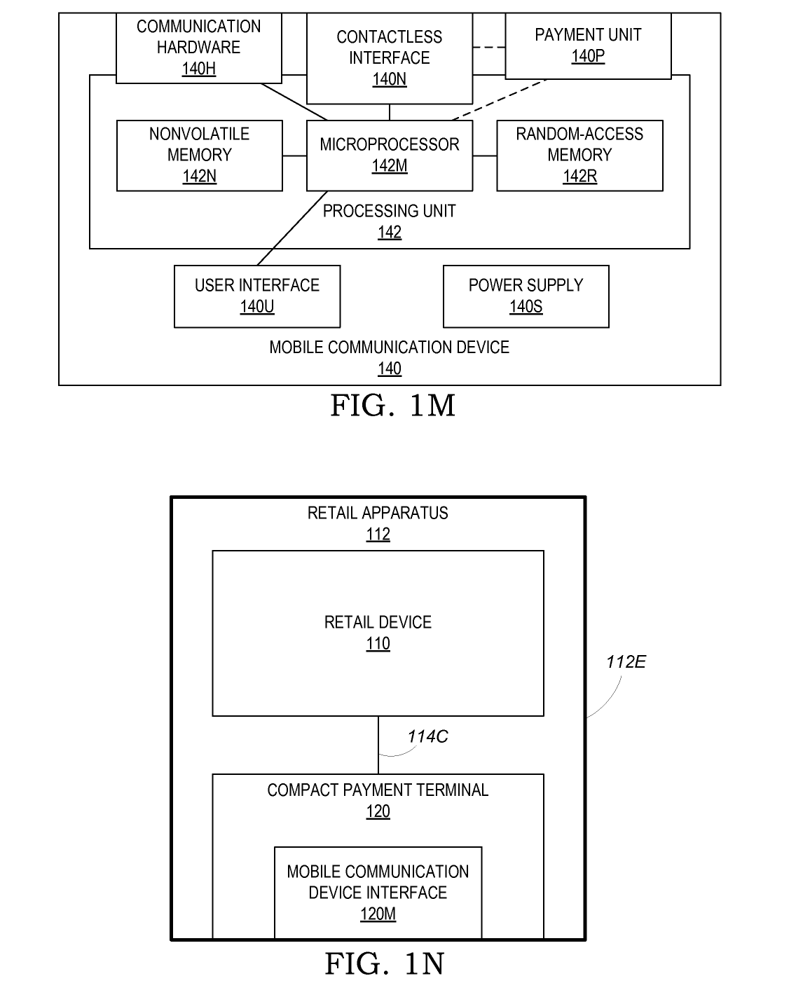

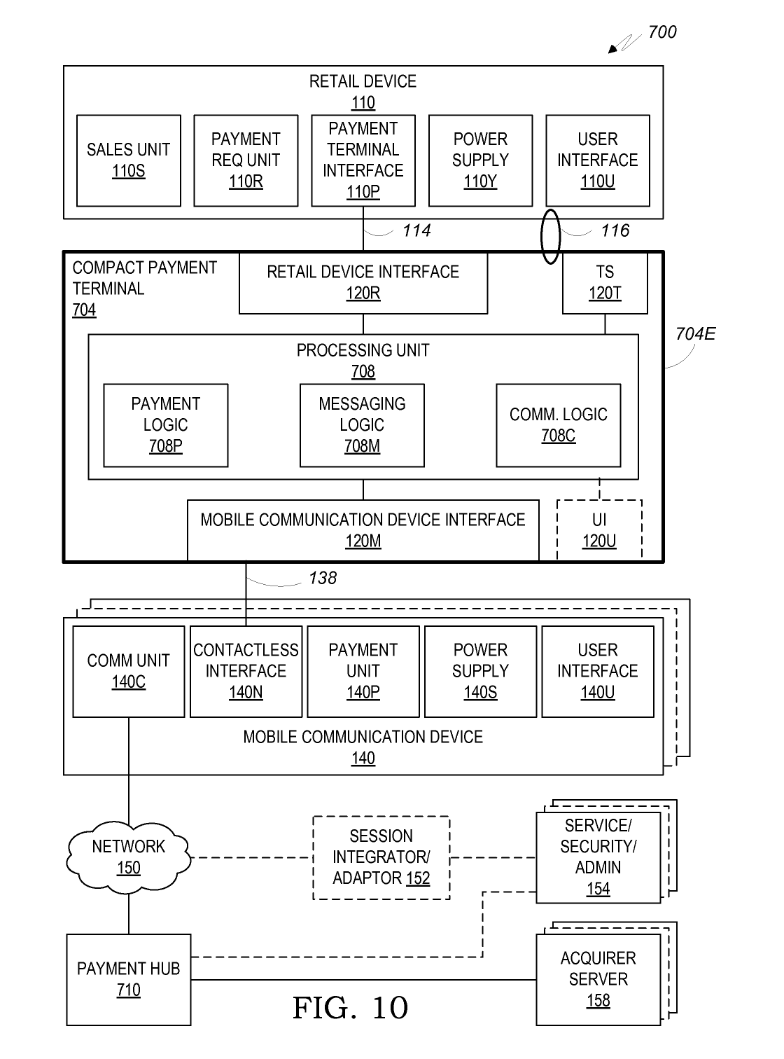

FIGS. 1-9 below describe standalone preferred embodiments of the compact payment terminal of the present invention, where a compact payment terminal handles payment, authorization and settlement. FIGS. 10-12 describe alternative preferred embodiments, where the compact payment terminal of the present invention is used for interfacing with the payment device and the retail device, while authorization and settlement, and possibly also part of the payment, are carried out at a payment hub.

### Standalone Compact Payment Terminals

Reference is made to FIG. 1, which describes a system 100 according to a preferred embodiment of the present invention. Compact payment terminal 120 is connected to retail device 110 to receive payment requests and acknowledge the success or failure of the payment. Compact payment terminal 120 also temporarily connects to a customer's mobile communication device 140, for interfacing with its payment unit 140P for making payments, and, selectably as needed, for interfacing with its communication unit 140C for communicating with an acquirer server 158 or with any of service, security & administration servers 154.

Retail device 110 may be any conventional attended or automated retail facility which serves customers on purchases of goods or services. Examples of retail device 110 include a manned cash register at a store or restaurant, a vending machine, a parking meter, and a mass transit ticket machine. Retail device 110 can also be a new kind of retail facility that is made economically-feasible for the first time by the present invention.

Retail device 110 includes a sales unit 110S that handles the supply and identification of items requested by or supplied to the customer. In automated retail, sales unit 110S is the vending machine or parking meter less the payment module, while in retail stores it is the scanner and/or the keyboard that is used by the cashier to identify the purchased items. Payment request unit 110R, presents a payment request for the amount due to the compact payment terminal 120, and expects a positive or negative payment confirmation in order to provide an electrical signal to sales unit 110S for providing the merchandise (in automatic retail), or a human-interpretable signal for a human operator to supply the goods or service or ask for an alternative payment form (in case of attended retail). User interface 110U, such as a keyboard, printer and screen, is used by the customer and/or a human operator in order to monitor and control the purchase process. User interface 110U preferably includes also a sticker with instruction for users of mobile communication device 140 with regard to using the device for payment. Power supply 110Y provides electrical power for the operation of all units of retail device 110, and possibly also for the operation of compact payment terminal 120, as will be described below.

Payment terminal interface 110P, connection 114 and retail device interface 120R determine how compact payment terminal 120 is electrically and logically connected to retail device 110; according to one preferred embodiment, they provide a conductive connection such as a wired universal serial bus (USB) connection; according to an alternative preferred embodiment, they provide a contactless connection, for example using near field communication technology (NFC) where payment terminal interface 110P is an active NFC chip energized from power supply 110Y, while compact payment terminal 120 includes an antenna of a passive NFC chip, thus connection 114 then uses electromagnetic radiation to both exchange data between retail device 110 and compact payment terminal 120 and energize compact payment terminal 120 by electromagnetic induction. Mechanical attachment 116 represents a conventional mechanical arrangement that secures compact payment terminal 120 to retail device 110 for protection and functional positioning.

Compact payment terminal 120 includes, within enclosure 120E, processing unit 130, retail device interface 120R, mobile communication device interface 120M and optionally also tampering sensor 120T. Retail device interface 120R is used for electrically and logically interfacing between processing unit 130 and retail device 110 via connection 114. Preferably but not necessarily, retail device interface 120R and connection 114 apply a wired interface for communication, and preferably also for supplying power for the operation of compact payment terminal 120 from power supply 110Y of retail device 110. Alternatively, retail device interface 120R may apply short-range communication technology, for example NFC communication, for both data exchange and energizing compact payment terminal 120 from power supply 110Y via electromagnetic induction. In the latter case, retail device interface 120R and mobile communication device interface 120M may be merged into a single NFC interface that serves compact payment terminal 120 for interfacing with both retail device 110 and mobile communication device 140. Mobile communication device interface 120M establishes, via radiofrequency connection 138, a temporary communication between compact payment terminal 120 and a visiting mobile communication device 140. If compact payment terminal 120 is not electrically energized from power supply 110Y of retail device 110, then mobile communication device interface 120M and radiofrequency connection 138 can be used for energizing compact payment terminal 120 from power supply 140S of mobile communication device 140 by electromagnetic induction. Radiofrequency connection 138 uses electromagnetic waves for communicating data between compact payment terminal 120 and mobile communication device 140, and possibly also for energizing compact payment terminal 120 from mobile communication device 140 by electromagnetic induction. Tampering sensor 120T is optionally included in the design of compact payment terminal 120, for disabling processing unit 130 upon detection of a tampering attempt. Such detection can be based on detecting the interruption of power supply from retail device 110 via connection 114, or by including a tearing sensor that detects when enclosure 120E is physically separated from retail device 110 or mechanical attachment 116 is broken. Incorporation of compact payment terminal 120 may be desirable if retail device 110 is an unattended automat, to reduce criminal motivation for stealing or tampering with compact payment terminal 120. User interface 120U is optional, and includes a keypad for entering a PIN, a fingerprint reader, and possibly also a display, for allowing user authentication directly with compact payment terminal 120, for enhanced security.

Processing unit 130 includes hardware and firmware for the operation of payment, settlement, messaging and communication functionalities. Payment logic 132 may handle any applicable combination of known payment methods that the merchant owning retail device 110 accepts, such as credit, debit, stored-value and charge & change. Notably, payment logic 132 may handle online payment authorization sessions with respective acquirers, if so required by a payment transaction. Settlement logic 134 handles settlement sessions corresponding to the payment methods accepted by payment logic 132. The protocols implemented by payment logic 132 and settlement logic 134 are preferably based on those of the payment logic and settlement logic of conventional payment terminal devices, with some modifications that are necessitated by the specifics of the operation of compact payment terminal 120, for example managing piecewise settlement sessions, as will be described later below. Messaging logic 136 is optionally included to enrich the services offered by compact payment terminal 120, by allowing the payment terminal to send security, maintenance and administrative message to selectable addressees via mobile communication device 140, which messages may be initiated by either compact payment terminal 120 or retail device 110. Communication logic 130C is included for the cooperation with visiting mobile communication devices 140 in order to address, initiate and manage authorization, settlement and messaging communication sessions with the respective acquirer(s) and other addressees.

Mobile communication device 140 is a personal portable communication device, such as a mobile telephone, two-way pager or personal digital assistant (PDA) that is carried by a user and includes a payment unit 140P and communication unit 140C. It also includes power supply 140S for energizing mobile communication device 140 and possibly also energizing compact payment terminal 120 via radiofrequency connection 138 by electromagnetic induction. User interface 140U included in mobile communication device 140 serves conventional communication functions of mobile communication device 140, as well as functions associated with payment and settlement, as will be described below. Mobile communication device 140 may also include additional functions, such as a digital camera, music player or GPS navigator, which are not related to the present invention and are therefore not shown. See to FIG. 1M below for some further detail with respect to mobile communication device 140.

Network 150 is one or more or a combination of communication networks, such as the Internet, cellular networks and private networks, that allow mobile communication devices 140 to connect with remote servers such as acquirer server 158 and service, security & administration servers 154. Each acquirer server 158 includes one or more of: credit/debit settlement processor 158C that has the necessary software and hardware for settling credit and/or debit transactions presented by merchant payment terminal devices; credit/debit authorization processor 158A that has the necessary software and hardware for handling credit and/or debit authorization requests presented by merchant payment terminal devices; and stored-value settlement processor 158S that that has the necessary software and hardware for handling stored-value settlements, optionally including, where applicable, charge & change settlement. It will be noted that a single compact payment terminal 120 may be served by one or more of acquirer server 158; for example, separate acquirer servers 158 may be contacted for settlement of different payment forms, such as credit, debit, stored-value or charge & change, or separate acquirer server 158 may be contacted for different brands of payment unit 140P, such as Visa, MasterCard, American Express or certain banks.

Service, security & administration servers 154 are an optional useful addition to system 100 of the present invention. They are operated by service providers that need to be automatically called or notified by service, security and/or administration messages received from compact payment terminal 120, originally generated either by processing unit 130 or the respective retail device 110. Also, a communication session between compact payment terminal 120 and any of service, security & administration servers 154 may allow the respective service provider to send messages, such as setup parameters or price-list updates, from the respective server, addressed to either compact payment terminal 120 or the respective retail device 110.

Session integrator/adaptor 152 is optionally devised for the case of piecewise communication sessions between compact payment terminal 120 and any of acquirer server 158 and service, security & administration servers 154; it may be also useful for easing the integration of compact payment terminal 120 of the present invention into existing infrastructures of acquirer server 158 and service, security & administration servers 154, that serves also conventional payment terminal devices. It will be noted that mobile communication device interface 120M and contactless interface 140N may offer a limited data flow that may be interrupted at any moment by a user prematurely removing mobile communication device 140 from the proximity of compact payment terminal 120. Accordingly, exchange of larger amounts of data, that may be typical to settlement and messaging sessions, may be broken to small pieces, and a piece that was not sent during the current purchase session via the current visiting mobile communication device 140, will be sent by settlement logic 134 or messaging logic 136 during the next purchase session by another visiting mobile communication device 140. Such piecewise communication may be handled in one of three ways: (i) by programming acquirer server 158 and/or service, security & administration servers 154 to receive and send files in pieces; (ii) by adding a software or hardware aggregator to the servers, so that messages are aggregated, and only when completed are integrated and presented for processing by the respective functional unit of the server; and (iii) by devising a separate session integrator server, that receives and aggregates all settlement and messaging messages from compact payment terminal 120 through visiting mobile communication devices 140, and only when a message is completed, will integrate and send the complete message to the addressed acquirer server 158 or service, security & administration servers 154. It will be appreciated that options (ii) and (iii) ease the integration of compact payment terminal 120 of the present invention into prior payment systems who serve also conventional payment terminal devices and are not programmed to handle piecewise messages. Accordingly, session integrator/adaptor 152 is either an adapter added to an existing server, or a standalone server that aggregates piecewise messages and integrates and relays them to the appropriate target servers upon the completion of each message. It will be noted that session integrator/adaptor 152 works also in the other direction, by receiving complete messages addressed to compact payment terminal 120, and sending them piecewise to the compact payment terminal 120, via a plurality of mobile communication devices 140 that visit compact payment terminal 120. It will also be noted that the adapter function of session integrator/adaptor 152 may provide protocol translation between the protocol that is best suited technically for the transfer of messages via contactless interface 140N and communication unit 140C, for example using short messages (SMS), and the protocols that are customary for data exchange between conventional payment terminal and their acquirer server. By providing such on-the-fly protocol translation for any or all of authorization, settlement and messaging, session integrator/adaptor 152 highly facilitates the integration of compact payment terminal 120 of the present invention into existing payment and settlement systems.

Reference is now made to FIGS. 1A-B, which highlight two alternative preferred embodiments for the implementation of mobile communication device interface 120M and retail device interface 120R. In the preferred embodiment of FIG. 1A, retail device interface 120R is implemented by a retail device conductive interface 120W that uses conductive wires and contacts to maintain communication and power supply between compact payment terminal 120A and retail device 110, while contactless interface 120N is used for exchanging data between compact payment terminal 120A and mobile communication device 140. In the preferred embodiment of FIG. 1B, a single contactless interface 120N is used for connecting compact payment terminal 120B with both retail device 110 and a mobile communication device 140, where one of these devices also supplies electrical energy for the operation of compact payment terminal 120B by electromagnetic induction.

FIG. 1C depicts the hardware components of processing unit 130 of compact payment terminal 120. Microprocessor 130M cooperating with random-access memory 130R executes all operations described herein, under code retrieved from nonvolatile memory 130N that is a computer-readable medium implemented as flash memory or alternative nonvolatile storage technology.

FIGS. 1D-G describe exemplary alternative embodiments of payment logic 132 of compact payment terminal 120 of FIG. 1, which differ by the payment forms accepted by compact payment terminal 120. Payment logic 132-1 includes charge payment module 132C for handling credit and debit payments. Payment logic 132-2 includes stored-value payment module 132V for handling stored-value payments. Payment logic 132-3 accommodates both a charge payment module 132C and a stored-value payment module 132V for handling any of credit, debit or stored-value payment according to the payment form of the visiting mobile communication device 140, or, if mobile communication device 140 contains more than one payment form, the payment form selected by the user using the user interface 140U of mobile communication device 140. Payment logic 132-4 handles credit and debit payments by charge payment module 132C, stored-value payments by stored-value payment module 132V, and charge & change payments by charge & change payment module 132CC.

FIGS. 1H and 1J-L describe exemplary alternative embodiments of settlement logic 134 of compact payment terminal 120 of FIG. 1. Settlement logic 134-1 includes charge settlement module 134C for handling credit and debit settlements. Settlement logic 134-2 includes stored-value settlement module 134V for handling stored-value settlements. Settlement logic 134-3 accommodates both a charge settlement module 134C and a stored-value settlement module 134V for handling credit, debit or stored-value settlement. Settlement logic 134-4 handles credit and debit settlements by charge settlement module 134C, stored-value settlements by stored-value settlement module 134V, and charge & change settlements by charge & change settlement module 134CC.

FIG. 1M adds detail to the description of some of the main components of mobile communication device 140 of FIG. 1. Processing unit 142 includes microprocessor 142M that collaborates with random-access memory 142R for running computer-executable code read from nonvolatile memory 142N that is a computer-readable medium implemented as flash memory or alternative nonvolatile storage technology. Processing unit 142 cooperates with communication hardware 140H, which includes an antenna and RF circuitry, for running all communication-related functions of mobile communication device 140. Processing unit 142 also provides to a user of mobile communication device 140 communication and other services via user interface 140U. Contactless interface 140N interfaces between processing unit 142 and compatible external devices that are equipped with a compatible contactless interface. Power supply 140S, preferably a battery, energizes all units of mobile communication device 140, and possibly also external devices that interface with contactless interface 140N.

Payment unit 140P may integrate into mobile communication device 140 in different ways, as demonstrated by the following examples:
Payment unit 140P may be logically disconnected from the other components of mobile communication device 140, for example in the form of a contactless sticker that is attached to the body of mobile communication device 140. In this case, payment unit 140P includes an autonomous contactless interface (not shown) that is independent of contactless interface 140N of mobile communication device 140.
Payment unit 140P may be a payment chip that is connected by conductors to contactless interface 140N and uses contactless interface 140N for interfacing with compact payment terminal 120.
Payment unit 140P may be a payment chip that is connected by conductors to microprocessor 142M through which it uses contactless interface 140N for interfacing with compact payment terminal 120.
Payment unit 140P and contactless interface 140N are integrated into a single contactless device that provides mobile communication device 140 with both contactless communication and payment functionalities.

All options above are workable and the selected choice among them depends on technical and commercial considerations.

Payment unit 140P includes, according to implementation considerations, one or more payment functions from credit, debit, stored-value and charge & change; credit, debit and stored-value payment are implemented according to conventional designs known to persons skilled in the art. Charge & change payment, as already noted above, is based on the cooperation between charge and stored-value functionalities of both a customer payment device and a merchant payment terminal, as taught by U.S. Pat. Nos. 5,744,787, 6,076,075, and optionally also U.S. Pat. Nos. 6,119,946, 6,467,685, 6,065,675, all of which are incorporated by reference as if set forth herein in their entirety.

FIG. 1N depicts an implementation wherein a retail device 110 and compact payment terminal 120 are hardwired to each other via conductive connection 114C and are integrated into a single retail apparatus 112 enclosed within retail apparatus enclosure 112E. For example, retail apparatus 112 may be an integrated parking meter or a ticketing machine that is equipped with a built-in compact payment terminal that is accessible to mobile communication devices 140 via mobile communication device interface 120M.

### Data Flow

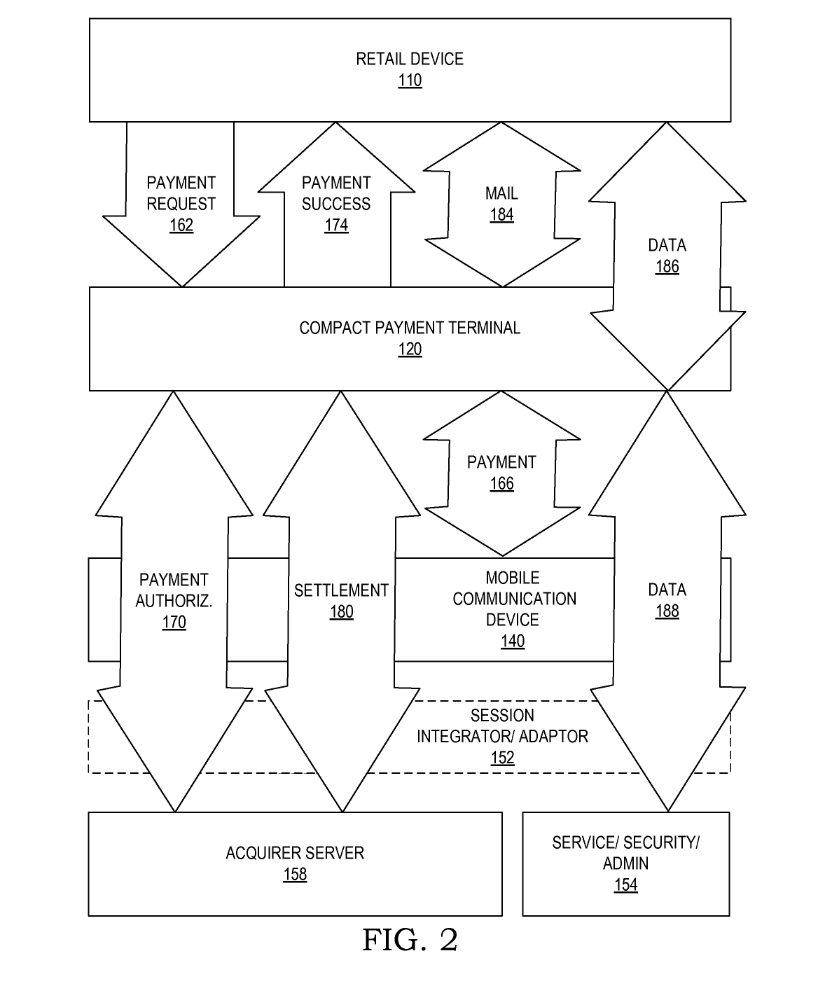

FIG. 2 describes the flow of data within system 100 of FIG. 1, in accordance with a preferred embodiment of the present invention. The participating components from system 100 are retail device 110, compact payment terminal 120 and mobile communication device 140, and preferably also service, security & administration servers 154 and session integrator/adaptor 152.

Retail device 110 determines the purchase price and presents a respective payment request message 162 to compact payment terminal 120. When a mobile communication device 140 is positioned in the proximity of compact payment terminal 120, a payment session 166 is initiated by compact payment terminal 120. If the completion of payment session 166 requires payment authorization, then a payment authorization session 170 is initiated by compact payment terminal 120 that exchanges authorization-related messages with the respective acquirer server 158 via contactless interface 140N and communication unit 140C of mobile communication device 140. Upon successful payment completion, possibly including successful payment authorization, compact payment terminal 120 sends to retail device 110 a payment success message 174 which may, at retail device 110, trigger an action such as merchandise supply and receipt printing.

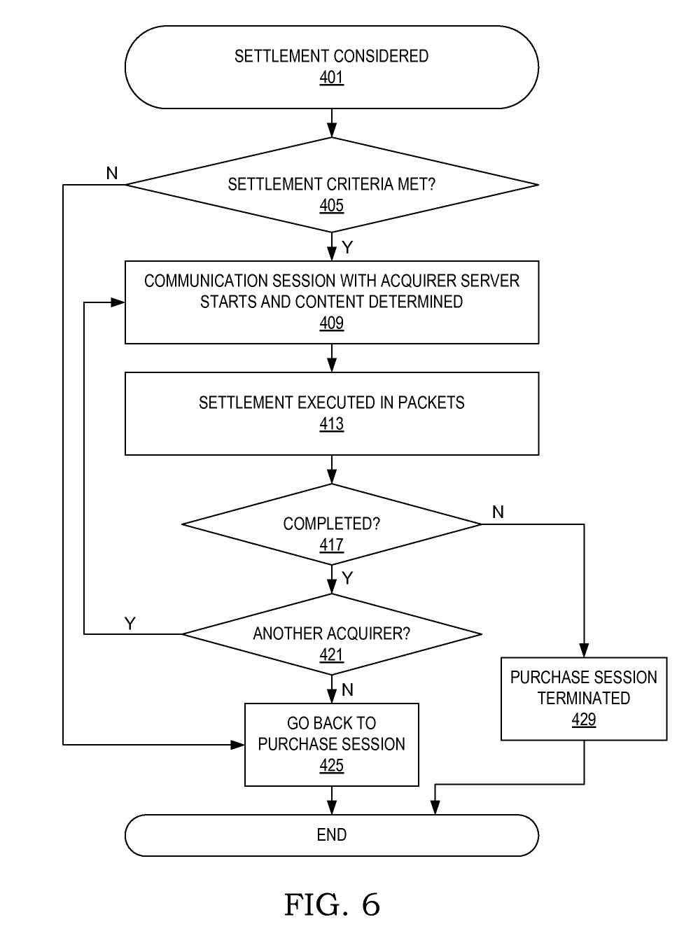

Upon certain criteria reached (see step 405 in FIG. 6 below) compact payment terminal 120 will initiate a settlement session 180 with acquirer server 158 when meeting a visiting a mobile communication device 140 that is presented in the proximity of compact payment terminal 120 for payment. Such settlement session may span across several visits of mobile communication devices 140 and may also involve several of acquirer server 158. Such splitting may be required for either organizing piecewise communication because of technical limitation of the communication channel that passes through contactless interface 140N and communication unit 140C (see below), or because settlement involves several payments forms (such as charge and stored-value) and/or several brands, which may require settlement with several of acquirer server 158.

Messaging, which is managed by messaging logic 136 of compact payment terminal 120, may involve service, security or administrative messages originated and/or received by retail device 110 and/or compact payment terminal 120, and are exchanged with one or more service, security & administration servers 154. In one mode of operation, messaging logic 136 maintains a mailbox for messages received from or addressed to retail device 110, and sends or receives such messages when a mobile communication device 140 is positioned next to compact payment terminal 120 for making payment. Messages originated by compact payment terminal 120 are exchanged with service, security & administration servers 154 by data exchange 188, while messages of retail device 110 may also be relayed to and from service, security & administration servers 154 by the real-time operation of data exchange 186 and data exchange 188 coordinated by messaging logic 136.

The communication between compact payment terminal 120 and acquirer server 158 or service, security & administration servers 154 is made via contactless interface 140N and communication unit 140C. It may use any applicable data transfer protocol, such as short text messaging (SMS) or mobile Internet protocols. At the time of the invention, commercial versions of contactless interface 140N are customarily using NFC technology with limited capacity for data transfer; hence it may be practical to handle longer messages, typical to settlement session 180 and messaging data exchange 188, in a piecewise mode, breaking each message into a number of smaller messages that are adequate for the contactless interface 140N. Such messages are sent consecutively, until the message is completed. However, an impatient user may remove his mobile communication device 140 from the proximity of compact payment terminal 120, thus interrupting the data transfer before a message is completed. Then, the next communication opportunity between compact payment terminal 120 and acquirer server 158 or service, security & administration servers 154, possibly via another mobile communication device 140, will be used for continuing sending the remainder of the message pieces.

Piecewise communication between compact payment terminal 120 and acquirer server 158 or service, security & administration servers 154 is straightforward to program at both ends. However, since acquirer server 158 and service, security & administration servers 154 may be existing servers that serve also conventional payment terminal devices that do not require piecewise messaging, it may be advantageous to provide session integrator/adaptor 152 as an intermediary between mobile communication device 140, and acquirer server 158 and service, security & administration servers 154. Session integrator/adaptor 152 can be implemented as an additional hardware and/or software module added to the respective servers, or alternatively as a standalone server that mediates communication between compact payment terminal 120 and acquirer server 158 and service, security & administration servers 154 via mobile communication device 140. Session integrator/adaptor 152 preferably also translates the communication protocols that are most suitable for contactless interface 140N and communication unit 140C, such as short messages (SMS), into the customary protocols used by acquirer server 158 and service, security & administration servers 154 for communicating with conventional payment terminal and payment hub devices.

It will be appreciated that with the evolution of technology and protocols for contactless communication, the need for piecewise communication, protocol translation and the very provision of session integrator/adaptor 152 may become obsolete.

### Operation

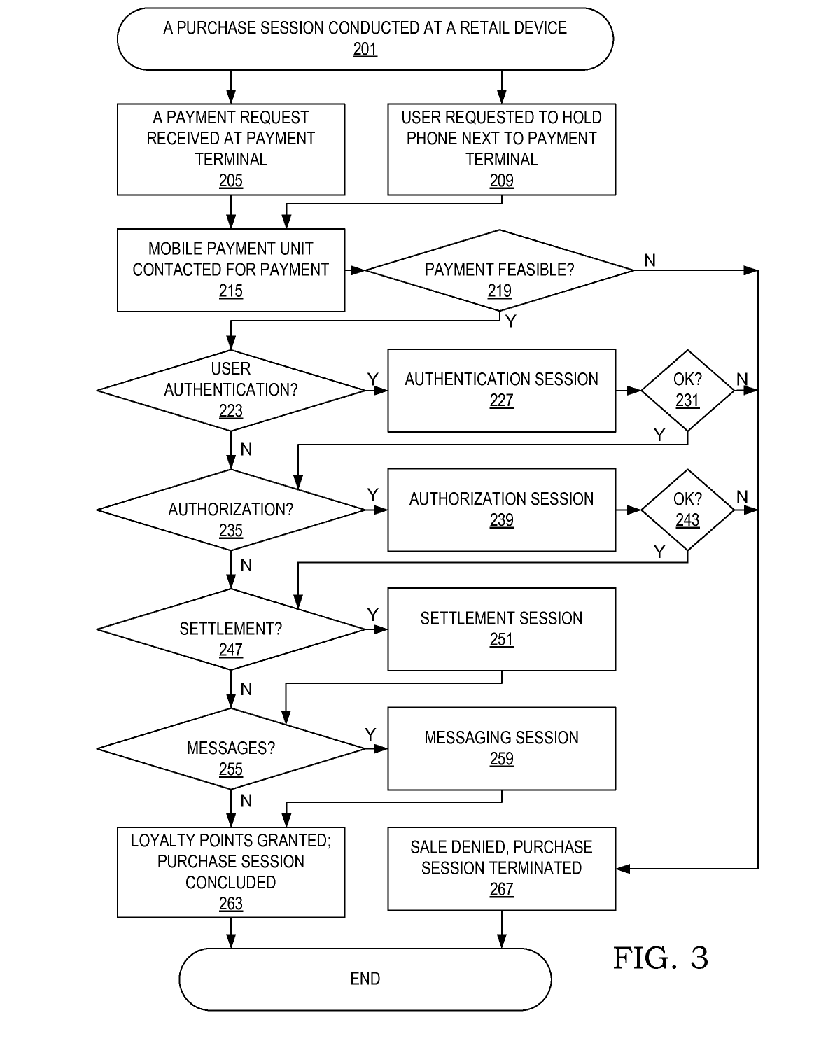

Reference is now made to FIG. 3, which is a schematic flowchart describing the operation of system 100 according to a preferred embodiment of the present invention. Operation starts in step 201, when a purchase process made at retail device 110 requires payment. In step 205, a payment request is presented by retail device 110 at compact payment terminal 120, and concurrently, in step 209 the customer is prompted to hold his or her mobile communication device in the proximity of mobile communication device interface 120M, by a message on user interface 110U such as by a blinking light next to a printed message or by a message shown on a LED or LCD display. In step 215, the mobile communication device interface 120M which has been placed by the customer next to compact payment terminal 120, is contacted by processing unit 130 through compact payment terminal 120, radiofrequency connection 138 and contactless interface 140N. In step 219, payment logic 132 checks whether mobile communication device 140 includes a payment unit 140P that is acceptable by compact payment terminal 120 for payment, and if the result is negating the session is terminated in step 267.

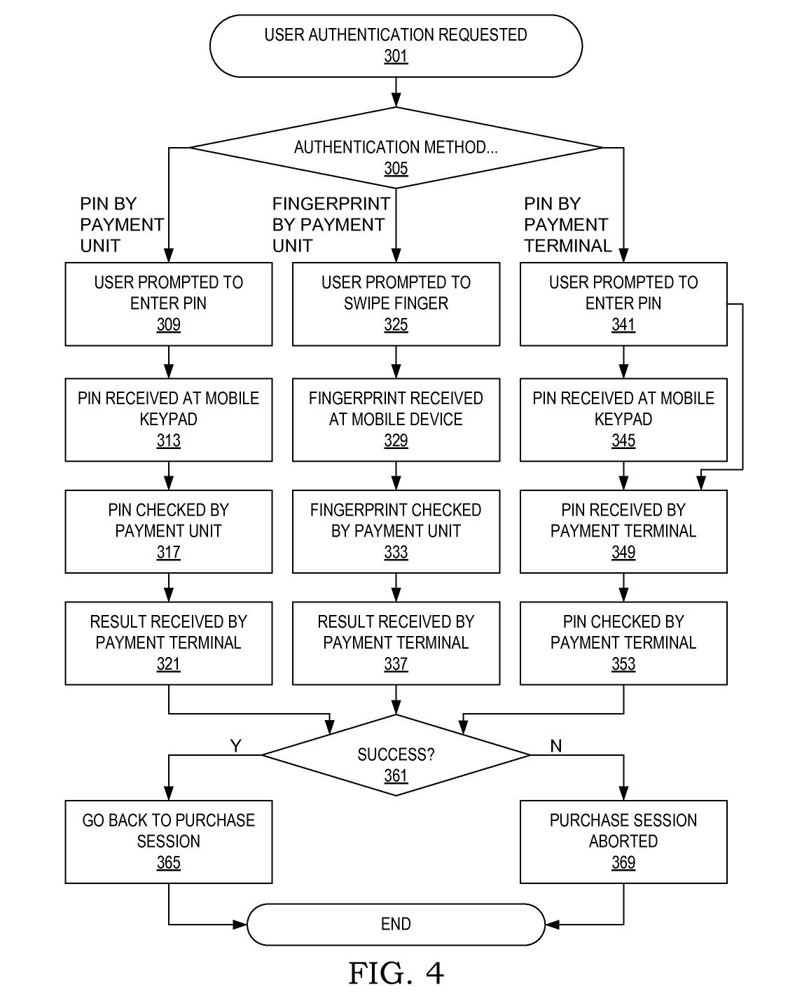

In step 223, payment logic 132 checks whether the current payment requires user authentication, which is determined by well-known criteria of the payment form, the payment amount, parameters recorded within payment unit 140P, and random factors. Criteria for requesting user authentication are well known to persons skilled in the art of payment systems and the present invention does not require changes in such customary criteria. If user authentication is required, then is step 227 and step 231 user authentication is executed and its results are checked, as will be described in more detail below with reference to FIG. 4.

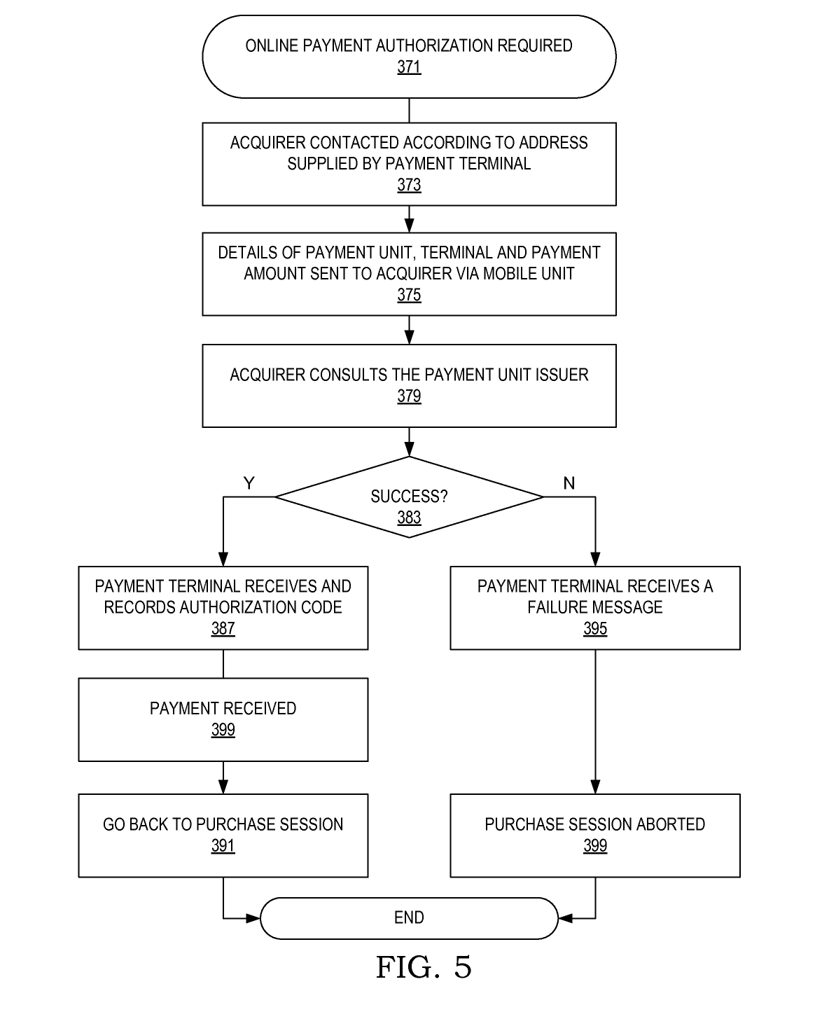

In step 235, payment logic 132 checks whether the current payment requires online authorization with an acquirer, which is determined by well-known criteria of the payment form, the payment amount, parameters recorded within payment unit 140P, and random factors. Criteria for requesting online authorization are well known to persons skilled in the art of payment systems and the present invention does not require changes in such customary criteria. If online authorization is required, then is step 239 and step 243 online authorization is executed and its results are checked, as will be described in more detail below with reference to FIG. 5.

In step 247, settlement logic 134 checks whether there is a need for a settlement session, and, if so, a settlement session is executed in step 251. Conditions for settlement and the settlement session are described below with reference to FIG. 6.

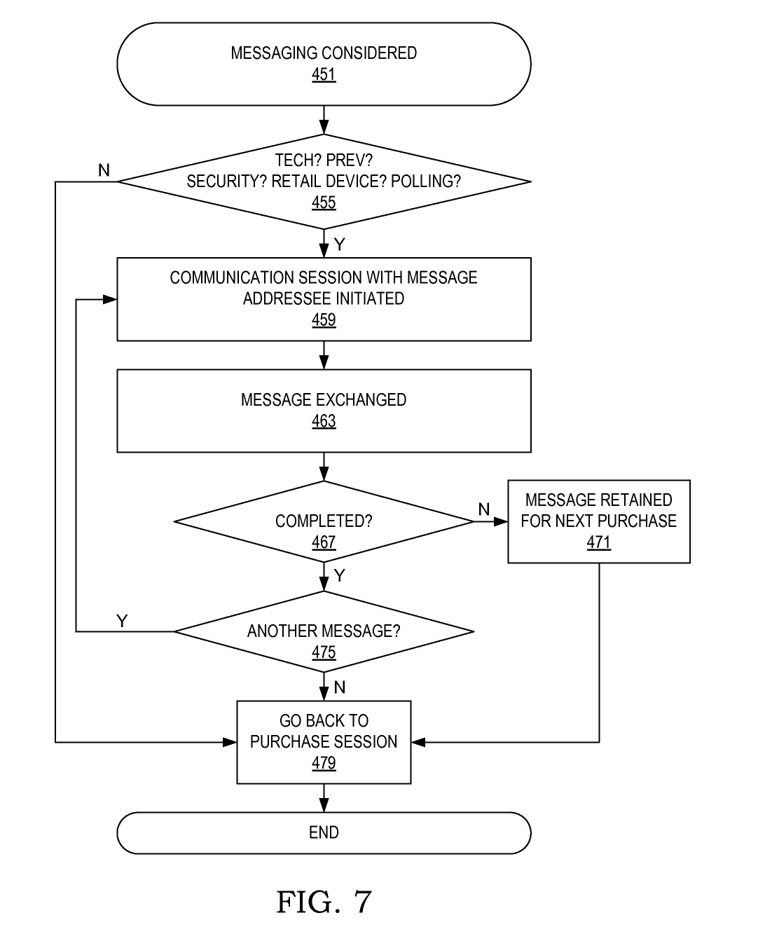

In step 255, messaging logic 136 checks whether there is a need for a messaging session, and, if so, a messaging session is executed in step 259. Conditions for messaging and the messaging session are described below with reference to FIG. 7.

In step 263 a purchase session, including payment and, if needed, settlement and messaging, is concluded, the user is advised, via user interface 140U or user interface 110U, on the session results and is encouraged to remove the mobile communication device 140 from compact payment terminal 120, and the procedure ends. Alternatively, in step 267 a purchase session is terminated without receiving payment, the user is advised, via user interface 140U or user interface User Interface 110U, on the session results and is encouraged to remove the mobile communication device 140 from compact payment terminal 120, and the procedure ends. Optionally, step 263 includes the grant of loyalty points or other voluntary incentives, in order to encourage the user to keep the mobile communication device 140 in the proximity of compact payment terminal 120 until the completion of step 251 and step 259. It will be appreciated that other means for encouraging users to keep their mobile communication devices may be used, such as a tray adapted to keep the mobile communication unit throughout the purchase session.

FIG. 4 is a flowchart describing the details of step 227 of FIG. 3. In step 301, it is determined that payer authentication is requested, according, for example, to the payment form (credit, debit, stored-value, charge & change), the payment amount and a random factor. In step 305 the payer authentication method is determined by the available hardware and software at mobile communication device 140.

In a first authentication method, it is the payment logic 132 of compact payment terminal 120 (FIG. 1) that requires authentication by a personal identification number (PIN) in order to unlock and operate. In this case, in step 309 the user is prompted by a message on the screen of user interface 140U of mobile communication device 140 to enter his or her PIN, and in step 313 the PIN is received at the keypad of user interface 140U. In step 317 the PIN is checked by payment unit 140P, and in step 321, the results are reported to compact payment terminal 120, which accordingly either continues the payment flow at step 235 of FIG. 3, or aborts the session at step 267 of FIG. 3. In a second authentication method, user interface 140U of mobile communication device 140 includes a fingerprint scanner, and payment unit 140P of mobile communication device 140 conditions its operation on successful scanning Is step 325 the user is prompted by a message on the screen of user interface 140U to swipe his or her finger; in step 329 the fingerprint is scanned by the fingerprint reader, and in step 333 the positive or negative result is determined at the mobile communication device 140 and then in step 337 it is reported to the payment terminal where, according to the result, step 361 determines whether the session will continue in step 365 or be aborted in step 369. In the third user authentication method it is the payment terminal that verifies the PIN. Thus, in step 341 the user is prompted by a message on the screen of user interface 140U to enter his or her PIN. In step 345 the PIN is received by the keypad of user interface 140U, which is then received by compact payment terminal 120 in step 349. Alternatively, the PIN may be entered directly at user interface 120U as part of step 349, and then step 341 is skipped. The PIN is then checked in step 353 by the payment terminal, with reference to other data received from payment logic 132 of compact payment terminal 120 and some secret information known and secured by the payment terminal. The positive or negative result then determines, in step 361, whether the session will continue in step 365 or be aborted in step 369.

FIG. 5 is a flowchart describing the details of step 229 of FIG. 3. Starting in step 371 after payment logic 132 has determined that online payment authorization is required, for example by the payment form, payment amount and a random factor, then in step 373 mobile communication device 140 establishes communication with the respective acquirer server 158 according to an address (such as Internet address or mobile communication address) received from compact payment terminal 120 via contactless interface 140N, and then in step 375 a request for authorization, along with the details of compact payment terminal 120, payment unit 140P of mobile communication device 140, and the payment amount, are sent by compact payment terminal 120, via mobile communication device interface 120M, radiofrequency connection 138, contactless interface 140N and network 150, to the credit/debit authorization processor 158A of the appropriate acquirer server 158. In step 379 the acquirer server 158 consults the issuer (not shown in FIG. 1) of payment unit 140P to verify that payment unit 140P is valid and can make the requested payment, and in step 383, the success or failure of the authentication is reported by credit/debit authorization processor 158A of acquirer server 158, which determines whether: the payment session will continue by recording the authorization code at the payment terminal in step 387, payment received in step 399, and the purchase session continues in step 391; or, in case of failure in step 383, in step 395 compact payment terminal 120 receives a failure message from acquirer server 158, and the purchase session is aborted in step 399.

FIG. 6 is a flowchart describing the details of step 227 and step 251 of FIG. 3. In step 401, payment has actually successfully completed, mobile communication device 140 is still maintained in the proximity of compact payment terminal 120 and maintains a communication therewith, and settlement is to be considered. In step 405, the following criteria are checked by settlement logic 134, with any positive outcome determining a positive need for a settlement session: (a) calendar time, for example according to a criterion that requires settlement every midnight or every Monday; (b) time elapsed since the previous settlement; (c) number of transactions since the previous settlement; (d) total amount of money received since the previous settlement; (e) amount of accumulated, transacted or needed storage value, if stored-value and/or charge & change payment forms are included; and (f) a former incomplete piecewise settlement transaction still pending. If none of these criteria is met, then no settlement is required and in step 425 the purchase session continues at step 255 of FIG. 3. If step 405 determines that settlement is required, then, in step 409 mobile communication device 140 establishes communication with a respective acquirer according to an address received from compact payment terminal 120 and determined by the payment records that need to be settled, and in step 413 settlement information starts to be sent from compact payment terminal 120 to acquirer server 158. This information may be sent in pieces, if so necessitated by the characteristics of mobile communication device interface 120M and contactless interface 140N. In step 417 processing unit 130 determines whether settlement has been completed, and if not, then the purchase session is concluded at step 429, with the user retail device 110 advised of the successful outcome of the payment, so that the purchased good or services can be supplied to the customer, and the customer is advised of the successful payment conclusion via user interface 110U of retail device 110.

If settlement has been completed with a current acquirer, then in step 421 it is checked whether settlement with another acquirer is needed, for example for settling another form of payment, such as stored-value, or settling another payment brand, in situations where separate acquirers settle different brands. If another acquirer is to be contacted, then the procedure returns to step 409, otherwise in step 425 the procedure returns to step 255 of FIG. 3.

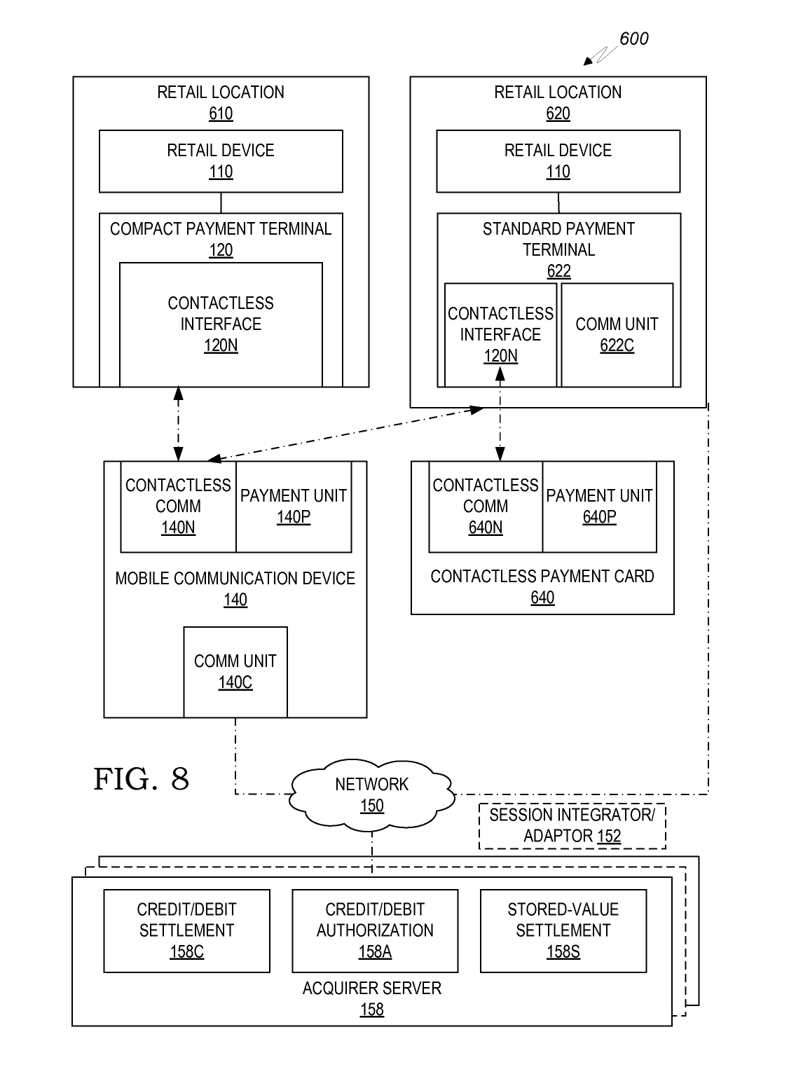

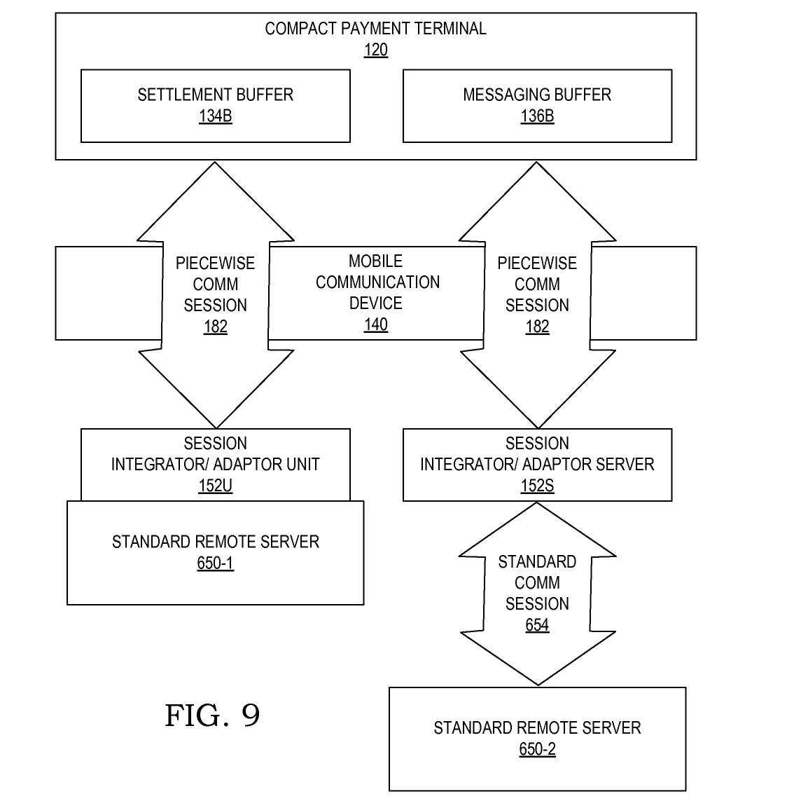

FIG. 7 is a flowchart describing the details of step 255 and step 259 of FIG. 3. In step 451 settlements is to be considered. In step 455, messaging logic 136 checks the need for messages: whether there is any technical, security or administrative event that needs to be reported; any request for communication or mail received from retail device 110; and any request for polling information from a specified addressee presented by any of the units of compact payment terminal 120 or by retail device 110. Such polling may be scheduled, as an example, for updating firmware, setup parameters or price-lists that are stored in retail device 110. If the result of step 455 is negative, then in step 459 the session resumes in step 263 of FIG. 3. If step 455 determines a positive need for sending and/or polling messages, then in step 459 messaging logic 136 initiates a communication session with a selected addressee, according to an address supplied by the message requesting unit (compact payment terminal 120 or retail device 110) and in step 463 messaging logic 136 sends or receives a message in a complete or piecewise mode (see FIGS. 8-9). If the message is completed in step 467, then in step 475 it is checked whether another message remains to be sent or polled, which determines whether the procedure will be repeated from step 459. If any message has not been completed at step 467 (for example, because the user has prematurely removed his mobile communication device 140 from compact payment terminal 120), then in step 471 the remainder of the messages, as well as unsent messages, are retained by messaging logic 136 for the next payment session.

Compatibility with Standard Systems

By standard payment terminal devices is meant standard payment terminal devices that have their own communication, power supply and user interface and are devised to handle payment transactions with contactless payment cards. Standard acquirer servers are acquirer servers that are devised to collaborate with standard payment terminal devices for authorization and settlement. Compact payment terminal 120 of the present invention differs from the standard payment terminal in relying on visiting mobile communication devices 140 for remote communication, by the implied communication protocols that take into account the nature of the communication that involves mobile communication device interface 120M, radiofrequency connection 138 and contactless interface 140N, and by other aspects described in this specification. It is advantageous to facilitate seamless integration of the compact payment terminal 120 of the present invention into standard systems.

FIG. 8 describes an extended payment system 600 that serves both a retail location 610 that employs compact payment terminal 120 of the present invention, and retail location 620 that employs a standard payment terminal 622 that includes its own communication unit 622C. Contactless payment card 640 is a standard payment card that includes a payment unit 640P and a contactless interface 640N is conventionally accepted at retail location 620. It could be accepted, under certain circumstances, also by compact payment terminal 120, for example if compact payment terminal 120 is energized from retail device 110 and online authorization is not required. However, mobile communication device 140 is accepted by compact payment terminal 120 of the present invention as described throughout the present specification, and is preferably also conventionally accepted by standard payment terminal 622 in a manner that is identical to the acceptance of a standard contactless payment card 640. Acquirer server 158 communicates, for online authorization and settlement sessions, with both standard payment terminal 622 through direct communication, and compact payment terminal 120 through mobile communication device 140. The difference between the communication methods of standard payment terminal 622 and compact payment terminal 120, may imply difference between the communication channels and protocols seen by acquirer server 158. Such differences can be resolved either by extending the capabilities of acquirer server 158 for handling communication channels and protocols, or by adding session integrator/adaptor 152 that transforms the communication channels and protocols used by compact payment terminal 120 for to communication channels and protocols similar to those of standard payment terminal 622, or by employing a payment hub as will be described below with reference to FIGS. 10-12.

FIG. 9 depicts the operation of session integrator/adaptor 152 of FIGS. 1 and 8, for handling piecewise communication sessions that may be necessitated by the nature of communication via mobile communication device interface 120M, radiofrequency connection 138 and contactless interface 140N under limitations known in the art at the time of the invention. For handling piecewise communication sessions for settlement and messaging, settlement logic 134 of compact payment terminal 120 manages a settlement buffer 134B, while messaging logic 136 manages messaging buffer 136B. Message pieces are then exchanged through a number of communication sessions made by compact payment terminal 120, typically via different visiting mobile communication devices 140. For handling such piecewise communication sessions with standard acquirer servers 158 or standard service, security & administration servers 154 (both shown as “standard remote server” in FIG. 9), a session integrator/adaptor 152 is provided in one of two configuration: either as an add-on unit session integrator/adaptor unit 152U implemented by software and/or hardware and added to the front-end of standard remote server 650-1, or as a separate session integrator/adaptor server 152S that receives and buffers session pieces and presents them as a standard communication session 654 to standard remote server 650-2. In both cases, standard remote server 650-1 and standard remote server 650-2 operate similarly with compact payment terminal 120 and standard payment terminal 622, with session integrator/adaptor 152, in the form of session integrator/adaptor unit 152U or session integrator/adaptor server 152S, covering for the differences.

A Compact Payment Terminal Collaborating with a Payment Hub

The preferred embodiments described so far related to a standalone payment unit, which handles complete payment, authorization and settlement transactions. FIGS. 10-12 below describe an alternative configuration, wherein the compact payment terminal of the present invention serves as a front end of a payment hub. This configuration may be advantageous for merchants that operate a large number of payment terminals.

FIG. 10 describes system 700 in which the tasks of compact payment terminal 120 of FIG. 1 are divided between compact payment terminal 704 and payment hub 710. Retail device 110, connection 114 and mechanical attachment 116 are similar to those of FIG. 1. compact payment terminal 704 is similar to compact payment terminal 120 of FIG. 1, except that processing unit 708 operates differently than processing unit 130, at least in the following aspects: (a) payment logic 708P addresses authorization requests to payment hub 710 (rather than directly to acquirer server 158); (b) payment logic 708P may address some stored-value related payment operations, such as storing the stored-value and making charge-and-change related selections, to payment hub 710 (rather than performing all of them by itself); (c) if terminal-level payer authentication is applied, part of the authentication checks may be done by payment hub 710; (d) messaging logic 708M operates either identically to messaging logic 136 or may relay part or all messages through payment hub 710. Also, processing unit 708 lacks settlement logic, and all payment records and settlement processes are handled by payment hub 710.

Payment hub 710 is a server maintained at a larger retail location or by a third-party service provider, for centrally managing payment, authorization and settlement for many individual payment terminals. This allows simplifying and reducing the cost of individual payment terminals, better securing the storage of transaction data and stored value, and increasing the size of transaction bulks presented to the respective acquirer(s), thereby allowing the negotiation of favorable processing fees. All other elements of system 700, including mobile communication devices 140, network 150, acquirer server 158, session integrator/adaptor 152, and service, security & administration servers 154 are similar to those of system 100 of FIG. 1. It will be noted that from the viewpoint of acquirer server 158, payment hub 710 may be seen as another managed services server of a larger merchant, and acquirer server 158 may remain unaware of the usage of the compact payment terminals 704 rather than conventional payment terminals that are mediated by a managed services server.

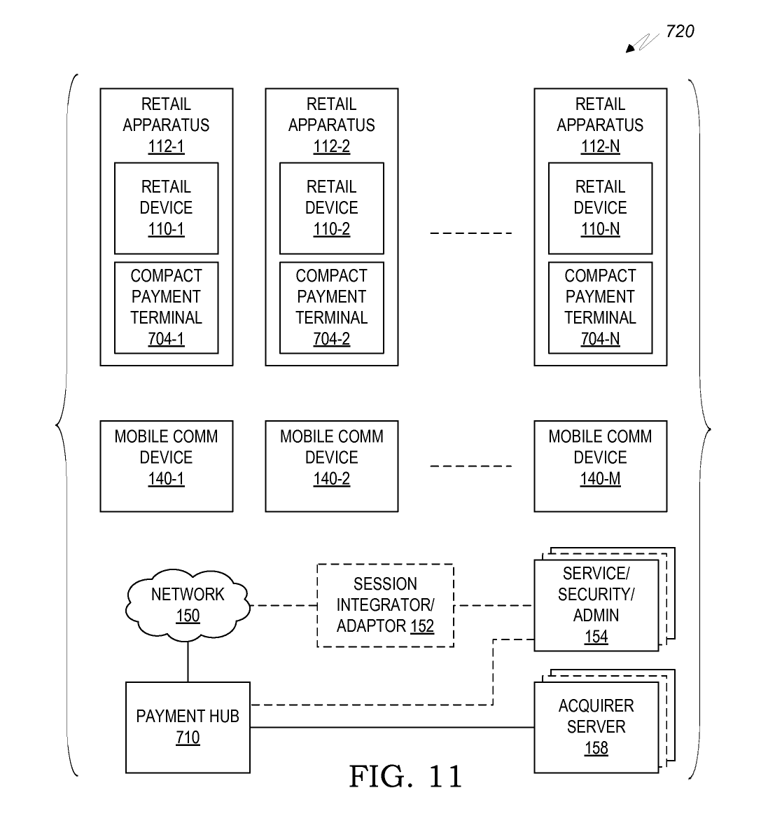

FIG. 11 describes a payment system 720, that serves a plurality of retail apparatuses 112-1 . . . 112-N, each including the respective retail device and compact payment terminal. Each of the retail apparatuses is visited for purchases by customers presenting their mobile communication device, which is any of 140-1 . . . 140-M, for payment. Upon payment, the visited compact payment terminal interfaces with the visiting mobile communication device for communicating with payment hub 710 and complete the payment, as described above with reference to FIG. 10. The arrangement of payment system 720 is advantageous for retail apparatuses such as vending machines, parking meters, kiosks etc., where a plurality of retail apparatuses belong to a single merchant or service authority.

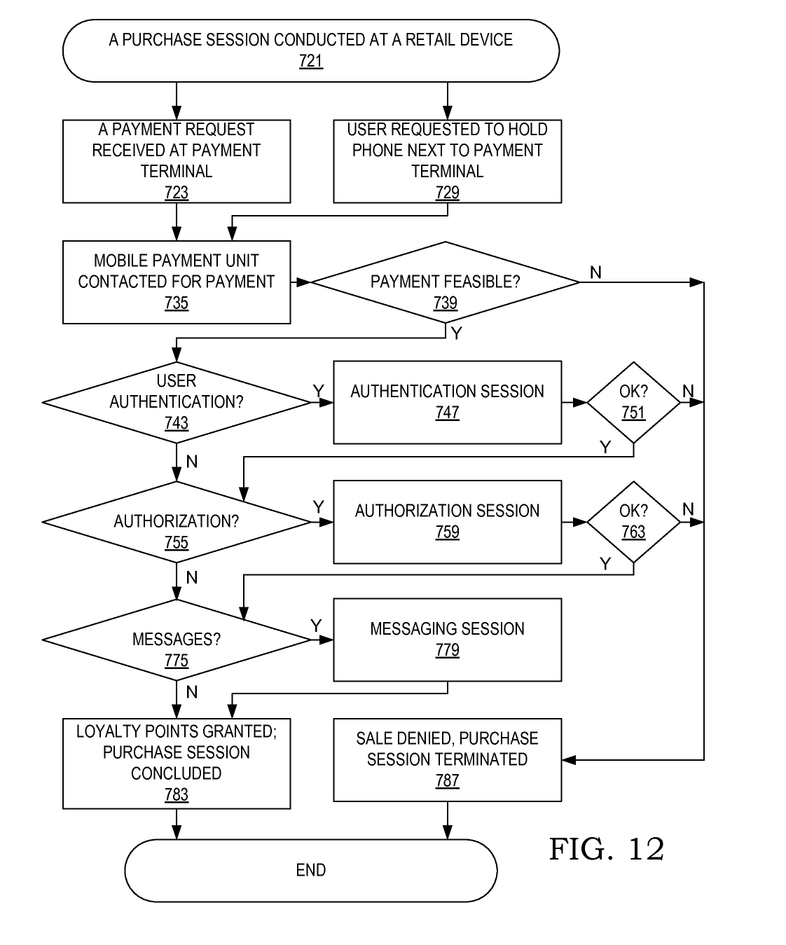

FIG. 12 is a flowchart depicting a purchase session at a compact payment terminal 704 of FIG. 10 in accordance to a preferred embodiment of the present invention. Operation starts in step 721, when a purchase process made at retail device 110 requires payment. In step 723, a payment request is presented by retail device 110 at compact payment terminal 704, and concurrently, in step 729 the customer is prompted to hold his or her mobile communication device in the proximity of mobile communication device interface 120M, by a message on user interface 110U such as by a blinking light next to a printed message or by a message shown on a LED or LCD display. In step 735, the mobile communication device interface 120M which has been placed by the customer next to compact payment terminal 120, is contacted by processing unit 130 through compact payment terminal 120, radiofrequency connection 138 and contactless interface 140N. In step 739, payment logic 708P checks whether mobile communication device 140 includes a payment unit 140P that is acceptable by compact payment terminal 704 for payment, and if the result is negating the session is terminated in step 787.

In step 223, payment logic 708P checks whether the current payment requires user authentication, which is determined by well-known criteria of the payment form, the payment amount, parameters recorded within payment unit 140P, and random factors. Criteria for requesting user authentication are well known to persons skilled in the art of payment systems and the present invention does not require changes in such customary criteria. If user authentication is required, then is step 747 and step 751 user authentication is executed, and its results are checked, as described above with reference to FIG. 4, but with possible consultation initiated by compact payment terminal 704 with payment hub 710 via a communication session through mobile communication device 140, for PIN checking, is step 353 is involved.

In step 755, payment logic 708P checks, possibly in consultation with payment hub 710, whether the current payment requires online authorization with an acquirer, which is determined by well-known criteria of the payment form, the payment amount, parameters recorded within payment unit 140P, and random factors. Criteria for requesting online authorization are well known to persons skilled in the art of payment systems and the present invention does not require changes in such customary criteria. If online authorization is required, then is step 759 and step 763 online authorization is executed by payment hub 710 and its results are reported to compact payment terminal 704.

In step 775, messaging logic 708M checks whether there is a need for a messaging session, and, if so, a messaging session is executed in step 779. Messaging is handled similarly to that described with reference to FIG. 7 above, with an option to relay all or part of the messages through payment hub 710.

In step 783 a purchase session, including payment and, if needed, messaging, is concluded, the user is advised, via user interface 140U or user interface 110U, on the session results and is encouraged to remove the mobile communication device 140 from compact 704, and the procedure ends. Alternatively, in step 787 a purchase session is terminated without receiving payment, the user is advised, via user interface 140U or user interface User Interface 110U, on the session results and is encouraged to remove the mobile communication device 140 from compact payment terminal 704, and the procedure ends. Optionally, step 783 includes the grant of loyalty points or other non-mandatory incentives, in order to encourage the user to keep the mobile communication device 140 in the proximity of compact payment terminal 704 until the completion of step 779.

### ADVANTAGES

An electronic payment system can be successful only if it offers advantages to customers, merchants, issuers and acquirers. Retail locations that feature low volume of business could not justify for merchants an/or acquirers the expense for installing electronic payment terminals in each such location. The present invention leverages existing user-interface, communication and computing resources that consumers already carry within their mobile communication devices, for enabling a compact, low-cost payment terminal that can be afforded at almost any retail location. This extends the convenience and security of electronic payment for consumers, and generates more business for merchants, acquirers and issuers.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

What is claimed is:

1. A retail apparatus for serving customers upon purchase, each customer carrying a mobile communication device for paying for the purchase, the retail apparatus comprising: a retail device and a compact payment terminal that are: (i) mechanically secured to each other, (ii) electrically connected so that the compact payment terminal receives power for its operation from the retail device, and (iii) logically connected for exchanging data with each other; wherein:
the retail device comprising: (i) a power supply, and (ii) a sales unit for handling supply of items to customers;
the compact payment terminal comprising: (i) a mobile communication device interface for exchanging data between the compact payment terminal and a paying mobile communication device positioned in proximity of the compact payment terminal, (ii) a retail device interface for receiving power from the power supply of the retail device and for exchanging data with the retail device, and (iii) a processing unit for the operation of functionalities of the compact payment terminal; and
the compact payment terminal is configured to:
receive power from the retail device for the operation of the compact payment terminal,
connect with a payment unit of the paying mobile communication device for receiving payment for the purchase,
connect with a communication unit of the paying mobile communication device for communicating, via the paying mobile communication device, with at least one server addressed by the compact payment terminal, and initiate a communication session with each of said at least one server, and
connect with the retail device for acknowledging payment success or failure.

2. The retail apparatus of claim 1, wherein said at least one server includes at least one of an acquirer server or a payment hub, and said communication session with each of said at least one server includes authorization of said payment for the purchase.

3. The retail apparatus of claim 1, wherein said at least one server includes at least one of an acquirer server or a payment hub, and said communication session with each of said at least one server includes at least part of a settlement session.

4. The retail apparatus of claim 1, wherein said at least one server includes at least one of a service server, an administration server, or a security server, and said communication session with each of said at least one server includes exchange of service, administration or security messages related to the compact payment terminal.

5. The retail apparatus of claim 1, wherein said at least one server includes at least one of a service server, an administration server, or a security server, and said communication session with each of said at least one server includes exchange of service, administration or security messages related to the retail device.

6. The retail apparatus of claim 1, wherein said receiving payment for the purchase is made by at least one of a charge transaction or a stored-value transaction.

7. The retail apparatus of claim 1, wherein the retail device is an automatic retail device.

8. The retail apparatus of claim 1, wherein the retail device includes at least one of a scanner or a keyboard.

9. A method for operating a compact payment terminal that is mechanically, electrically and logically connected to a retail device, for serving customers upon purchase, each customer carrying a mobile communication device for paying for the purchase, the method comprising:
receiving power from a power supply of the retail device for the operation of the compact payment terminal;
while a paying mobile communication device is in proximity of the compact payment terminal:
connecting with a payment unit of the paying mobile communication device for receiving payment for the purchase, and
connecting with a communication unit of the paying mobile communication device for communicating, via the paying mobile communication device, with at least one server addressed by the compact payment terminal, and initiating a communication session with each of said at least one server; and
connecting with the retail device for acknowledging payment success or failure.

10. The method of claim 9, wherein said at least one server includes at least one of an acquirer server or a payment hub, and said initiating a communication session with each of said at least one server includes initiating authorization of said payment for the purchase.

11. The method of claim 9, wherein said at least one server includes at least one of an acquirer server or a payment hub, and said initiating a communication session with each of said at least one server includes initiating at least part of a settlement session.

12. The method of claim 9, wherein said at least one server includes at least one of a service server, an administration server, or a security server, and said initiating a communication session with each of said at least one server includes initiating exchange of service, administration or security messages related to the compact payment terminal.

13. The method of claim 9, wherein said at least one server includes at least one of a service server, an administration server, or a security server, and said initiating a communication session with each of said at least one server includes initiating exchange of service, administration or security messages related to the retail device.

14. The method of claim 9, wherein said receiving payment for the purchase is made by making at least one of a charge transaction or a stored-value transaction.

15. A compact payment terminal for serving customers upon purchase, each customer carrying a mobile communication device for paying for the purchase, the compact payment terminal attached or attachable to a retail device that handles supply of items to customers, so that the compact payment terminal and the retail device are: (i) mechanically secured to each other, (ii) electrically connected so that the compact payment terminal receives power for its operation from the retail device, and (iii) logically connected for exchanging data with each other, the compact payment terminal comprising:
a mobile communication device interface for exchanging data between the compact payment terminal and a paying mobile communication device positioned in proximity of the compact payment terminal;
a retail device interface for receiving power from the power supply of the retail device and for exchanging data with the retail device; and
a processing unit for the operation of functionalities of the compact payment terminal;
wherein the compact payment terminal is configured to:
receive power from the retail device for the operation of the compact payment terminal;
connect with a payment unit of the paying mobile communication device for receiving payment for the purchase;
connect with a communication unit of the paying mobile communication device for communicating, via the paying mobile communication device, with at least one server addressed by the compact payment terminal, and initiate a communication session with each of said at least one server; and
connect with the retail device for acknowledging payment success or failure.

16. The compact payment terminal of claim 15, wherein said at least one server includes at least one of an acquirer server or a payment hub, and said communication session with each of said at least one server includes authorization of said payment for the purchase.

17. The compact payment terminal of claim 15, wherein said at least one server includes at least one of an acquirer server or a payment hub, and said communication session with each of said at least one server includes at least part of a settlement session.

18. The compact payment terminal of claim 15, wherein said at least one server includes at least one of a service server, an administration server, or a security server, and said communication session with each of said at least one server includes exchange of service, administration or security messages related to the compact payment terminal.

19. The compact payment terminal of claim 15, wherein said at least one server includes at least one of a service server, an administration server, or a security server, and said communication session with each of said at least one server includes exchange of service, administration or security messages related to the retail device.

20. The compact payment terminal of claim 15, wherein said receiving payment for the purchase is made by at least one of a charge transaction or a stored-value transaction.
